(19) United States
(12) Patent Application Publication
(10) Pub. No.: US 2026/0133854 A1
(43) Pub. Date: May 14, 2026

(54) System and Method for Realtime Carbon Aware Resource Allocation for Graphics Processing Unit (GPU) Intensive Tasks

(71) Applicant: Bank of America Corporation, Charlotte, NC (US)

(72) Inventors: Maharaj Mukherjee, Poughkeepsie, NY (US); Rahul Uniyal, Uttarakhand (IN); Carl Benda, Charlotte, NC (US)

(21) Appl. No.: 18/942,878

(22) Filed: Nov. 11, 2024

(51) Int. Cl. G06F 9/50; G06F 9/54; G06T 1/20

(52) U.S. Cl. CPC G06F 9/5094; G06F 9/54; G06T 1/20; G06F 2209/543

(57) ABSTRACT

A computing platform may train, using code specific information, temporal information, and compute specific information, a CO2 minimization model to output, for a given processing request, a resource allocation recommendation. The computing platform may input a processing request into the CO2 minimization model to output a resource allocation recommendation indicating processing resources for use in executing the processing request with a minimal amount of CO2 emissions. The computing platform may cause the task execution platform to execute the processing request using the processing resources of the resource allocation recommendation. The computing platform may: dynamically monitor the task execution platform to collect, in real time, metadata associated with execution of the processing request, generate, using the CO2 minimization model, updated resource allocation recommendations based on the real time metadata, and cause the task execution platform to shift the processing for the processing request to the updated resources.

### BACKGROUND

In some instances, tasks that may be compute intensive (e.g., high frequency trading, generative artificial intelligence, metaverse, or the like) may require special purpose hardware such as graphics processing units (GPU). However, such special purpose hardware using GPU may consume significant energy, and thus may create a significant carbon footprint. This may present a challenge for organizations trying to achieve a net zero carbon emission target.

### SUMMARY

Aspects of the disclosure provide effective, efficient, scalable, and convenient technical solutions that address and overcome the technical problems associated with balancing compute intensive processing with CO₂ emissions. In accordance with one or more embodiments of the disclosure, a computing platform comprising at least one processor, a communication interface, and memory storing computer-readable instructions may train, using code specific information, temporal information, and compute specific information, a carbon dioxide (CO2) minimization model, where training the CO2 minimization model configures the CO2 minimization model to output, for a given processing request, a resource allocation recommendation. The computing platform may receive a first processing request. The computing platform may input the first processing request into the CO2 minimization model, which may cause the CO2 minimization model to output a first resource allocation recommendation indicating processing resources for use in executing the first processing request with a minimal amount of CO2 emissions. The computing platform may send one or more commands to a task execution platform directing the task execution platform to execute the first processing request using the processing resources of the first resource allocation recommendation, which may cause the task execution platform to execute the first processing request using the processing resources of the first resource allocation recommendation. Until completion of the first processing request, the computing platform may: 1) dynamically monitor the task execution platform to collect, in real time, metadata associated with execution of the first processing request, 2) generate, using the CO2 minimization model, updated resource allocation recommendations based on the real time metadata, and 3) send updated commands to the task execution platform directing the task execution platform to shift processing for the first processing request to updated resources indicated in the updated resource allocation recommendations, which may cause the task execution platform to shift the processing for the first processing request to the updated resources. The computing platform may update, based on the real time metadata, the CO2 minimization model.

In one or more instances, the code specific information may include one or more of: 1) historical information such as one or more of: training information, run information, infrastructure history information, carbon emission history information, or code history cache information, 2) task information such as one or more of: high frequency trading information, gaming information, generative artificial intelligence information, computer vision information, natural language processing information, augmented reality information, virtual reality information, blockchain information, or crypto currency information, or 3) model type information. In one or more instances, the temporal information may be one or more of: day information, time information, or holiday information.

In one or more examples, the compute specific information may be one or more of: 1) infrastructure information including one or more of: thermal design power information, graphics processing unit (GPU) lifespan information, hardware information, recycling information, cooling information, GPU type, GPU name, GPU memory, central processing unit (CPU) type, CPU name, or CPU memory, 2) geographical information including one or more of: country information, state information, or distance information, or 3) energy information including one or more of: energy source information, grid information, or carbon intensity information, where the carbon intensity information may indicate a kilogram (kg) per mega watt hour of CO2 emission for a corresponding energy source, and the corresponding energy source may include one or more of: a coal source, a solar source, a wind source, a nuclear source, a hydro source, or a natural gas source. In one or more examples, the given processing request comprises a request to process a task using a GPU.

In one or more instances, the processing resources may be associated with a codebase, and the CO2 minimization model may be further trained using the codebase. In one or more instances, the real time metadata may be one or more of: energy consumption, memory bandwidth, device utilization, dynamic carbon saving parameters, or static carbon saving parameters, where the static carbon saving parameters comprise one or more of: resource lifespan information, recycling information, task information, hardware information, or TDP information. In one or more instances, the first resource allocation recommendation may include a mapping for execution of a code associated with the first processing request to a particular processing resource.

In one or more examples, the computing platform may send, to a user device associated with the first processing request, a carbon aware infrastructure recommendation based on the resource allocation recommendation, where the carbon aware infrastructure recommendation provides an indication of an amount of CO2 savings associated with implementation of the resource allocation recommendation, and where sending the carbon aware infrastructure recommendation causes the user device to display the carbon aware infrastructure recommendation. In one or more examples, the computing platform may generate, based on the CO2 minimization model, green house gas (GHG) vectors. The computing platform may send, to a third party system, the GHG vectors, where the third party system may be configured to implement the CO2 minimization model based on the GHG vectors.

### BRIEF DESCRIPTION OF DRAWINGS

The present disclosure is illustrated by way of example and is not limited in the accompanying figures in which like reference numerals indicate similar elements and in which:

FIGS. 1A and 1B depict an illustrative computing environment for performing real time carbon aware resource allocation for graphics processing unit (GPU) intensive tasks in accordance with one or more example embodiments.

FIGS. 2A-2E depict an illustrative event sequence for performing real time carbon aware resource allocation for graphics processing unit (GPU) intensive tasks in accordance with one or more example embodiments.

FIG. 3 depicts an illustrative method for performing real time carbon aware resource allocation for graphics processing unit (GPU) intensive tasks in accordance with one or more example embodiments.

FIG. 4 depicts an illustrative user interface for performing real time carbon aware resource allocation for graphics processing unit (GPU) intensive tasks in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

In recent years, many computing intensive tasks rely on special purpose hardware such as graphics processing units (GPU) due to modern business requirements within applications such as high frequency trading (HFT), generative artificial intelligence, metaverse, and/or other applications.

Unbeknown to many, however, such special purpose hardware using GPU may use a lot of energy within the data centers, and may create significant carbon footprints as a result. Unfortunately, this may be challenging for many organizations trying to achieve a net zero carbon footprint.

Various foundational models, HFT algorithms, blockchain applications, or the like created by developers to optimize for faster infrastructure may often be designed and implemented without having any consideration for the reduction of a carbon footprint. Optimizing multi-GPU systems for diverse computational workloads while minimizing energy consumption and carbon footprint may present significant computational challenges. Additionally, no official/global guidelines (e.g., detailed information on how one may reduce emission using a particular technique in a particular location at a particular time) are available to save on carbon footprint. As a result, it may be important to provide a solution for a system and method for real-time carbon aware resource allocation for GPU intensive tasks.

The following sub-methods may be applied in the arrangements presented herein.

Codebase—various code repositories in an organization. It may include various programming languages, database scripts, operating system scripts, extract load transform (ELT), or the like. All this may be sent to a CO2 minimization model.

Temporal info—this may include various time specific information about current jobs, codes, infra, or the like. This kind of information may help systems to optimize carbon emissions using time and location to run a particular code.

Code specific information—code specific information may contain the following information for a given code/script: history information (e.g., information about various previous runs of given code, including time to train/infrastructure a model, carbon emission/infrastructure usage history, or the like), task information (what task current code is about to perform, such as high frequency trading, generative artificial intelligence, video editing, crypto mining, or the like), model information (e.g., memory, parameters, context length, or the like), or the like.

Compute specific information—compute specific information may contain the following information for a given code/script: infrastructure information (e.g., various capabilities and features of infrastructure used, such as thermal power design, CPU/GPU lifespan, GUP/CPU type info and memory, RAM information), geographical information (e.g., country, state, distance from model/data/edge devices) that may guide a model to identify a best location from a carbon emission perspective, energy information (e.g., static information containing given carbon intensity for a particular energy source, dynamic information like grid usage to identify optimal location to run code, or the like), or the like.

Carbon aware infrastructure recommendation—CO2 minimization model may provide various recommendations for optimizing running of the code to save carbon emissions. It may also indicate an amount of CO2 emissions one may save if they switch to a suggested alternative. The alternative recommendation may be in the form of mapping (e.g., Code A: GPU2: .02-ton CO2 emissions saved in a year).

A CO2 minimization model may receive various inputs like code, infra, infrastructure usage, or the like. Using a large history of these operations and other infra/emission specific info (energy consumption, memory bandwidth, device utilization, or the like), the CO2 minimization model may be able to recommend a most optimal device, time, location, or the like to run a code/job. It may recommend the device, and the device may be set via a configuration.

A real time resource allocator may allocate infrastructure based on given code requirements. It may allocate CPU/GPU/memory in real time for given code/script. This real time resource allocator may optimize CO2 emissions usage for this. Additionally, it may use a system specific configuration/threshold to allocate or not allocate provided infrastructure in real time. This way, one may configure a system, application, organization, operating system, or the like to implement it partially.

Various learned information may be saved as green house gas vectors by the CO2 minimization model. After removing organization specific sensitive information, these vectors may be shared with other organizations to reduce CO2 emissions at a global level.

In summary, a system and method that would help any organization to optimize its infrastructure to reduce carbon emission is described. It may identify optimal CPU/GPU memory to run a given code/script. Global green house gas vectors may be saved for the greater good. It may help other organizations as well as saving carbon credit. Additionally, source organizations may claim shared carbon credits from them.

The CO2 minimization model may recommend optimal resources to run a particular code/script. It may also tell jobs to be run in a particular time and location. Moreover, it may recommend various infrastructure components to be included, removed, or replaced from an existing system. In some cases, it may recommend to switch to some other infrastructure (e.g., server to edge device, GPU to CPU, or vice versa).

Unlike typical resource allocation, our system may consider carbon footprint before allocating a compute resource. It may also consider data/network, or the like, to allocate these resources. To provide a more affective actionable recommendation, it may also translate a given emission save in a relatable manner (e.g., tree plantation, LED usage, or the like).

These and other features are described in greater detail below.

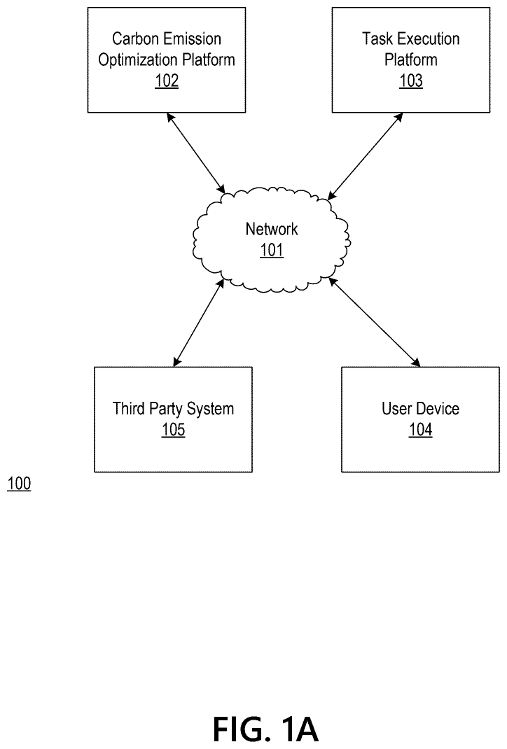

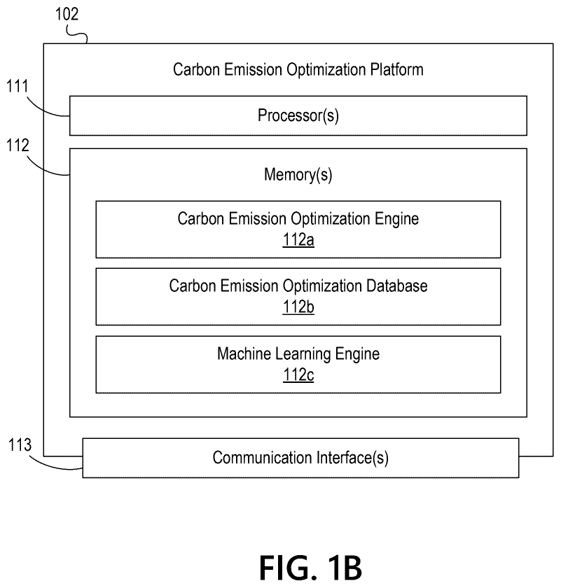

FIGS. 1A-1B depict an illustrative computing environment for performing real time carbon aware resource allocation for graphics processing unit (GPU) intensive tasks in accordance with one or more example embodiments. Referring to FIG. 1A, computing environment 100 may include one or more computer systems. For example, computing environment 100 may include carbon emission optimization platform 102, task execution platform 103, user device 104, and third party system 105.

Carbon emission optimization platform 102 may include one or more computing devices (servers, server blades, or the like) and/or other computer components (e.g., processors, memories, communication interfaces, or the like). For example, the carbon emission optimization platform 102 may be configured to train, host, and apply a CO2 minimization model, configured to leverage code specific information (e.g., historical information (e.g., training information, run information, infrastructure history information, carbon emission history information, code history cache information, or the like), task information (high frequency trading information, gaming information, generative artificial intelligence information, computer vision information, natural language processing information, augmented reality information, virtual reality information, blockchain information, crypto currency information, or the like), model type information, or the like), temporal information (day information, time information, holiday information, or the like), compute specific information (infrastructure information (e.g., thermal design power information, graphics processing unit (GPU) lifespan information, hardware information, recycling information, cooling information, GPU type, GPU name, GPU memory, central processing unit (CPU) type, CPU name, CPU memory, or the like), geographical information (e.g., country information, state information, distance information, or the like), energy information (energy source information (e.g., a coal source, a solar source, a wind source, a nuclear source, a hydro source, a natural gas source, or the like), grid information, carbon intensity information indicating a kilogram (kg) per mega watt hour of CO2 emission for a corresponding energy source, or the like), or the like), codebase information, and/or other information to generate, for a given processing request, a resource allocation recommendation indicating processing resources that may be used to execute the request while minimizing an amount of CO2 emissions. In some instances, carbon emission optimization platform 102 may be configured to dynamically update the CO2 minimization model based on user feedback, metadata from a task execution platform (e.g., energy consumption, memory bandwidth, device utilization, dynamic carbon saving parameters, static carbon saving parameters (e.g., resource lifespan information, recycling information, task information, hardware information, TDP information, or the like), or the like). Any number of such carbon emission optimization platforms 102 may be used to implement the techniques described herein without departing from the scope of the disclosure.

Task execution platform 103 may be or include one or more computing devices (e.g., graphics processing units (GPU), central processing units (CPU), servers, server blades, or the like) and/or other computer components (e.g., processors, memories, communication interfaces, or the like). For example, task execution platform 103 may be configured to perform one or more compute intensive tasks such as tasks related to high frequency trading, gaming, generative artificial intelligence (AI), computer vision, natural language processing, augmented reality (AR), virtual reality (VR), blockchain, cryptocurrency, or the like. Any number of such task execution systems may be used to implement the techniques described herein without departing from the scope of the disclosure. User device 104 may be or include one or more devices (e.g., laptop computers, desktop computer, smartphones, tablets, and/or other devices) configured for use in communicating with carbon emission optimization platform 102, the task execution platform 103, and/or third party system 105. For example, the user device 104 may be used to receive and display carbon aware infrastructure recommendations (e.g., based on outputs from the CO2 minimization models). In some instances, the user device 104 may be configured to display one or more graphical user interfaces (e.g., recommendation interfaces, or the like). Any number of such user devices may be used to implement the techniques described herein without departing from the scope of the disclosure.

Third party system 105 may be or include one or more computing devices (servers, server blades, or the like) and/or other computer components (e.g., processors, memories, communication interfaces, or the like), which may, e.g., be configured to initialize a CO2 minimization model similar to the CO2 minimization model trained by the carbon emission optimization platform 102. For example, the third party system 105 may initialize the CO2 minimization model using green house gas (GHG) vectors provided, for example, from the CO2 minimization model. In some instances, the third party system 105 may be maintained by, associated with, and/or otherwise affiliated with an enterprise organization different than the enterprise organization associated with the carbon emission optimization platform 102. Any number of such third party systems may be used to implement the techniques described herein without departing from the scope of the disclosure.

Computing environment 100 also may include one or more networks, which may interconnect carbon emission optimization platform 102, task execution platform 103, user device 104, and third party system 105. For example, computing environment 100 may include a network 101 (which may interconnect, e.g., carbon emission optimization platform 102, task execution platform 103, user device 104, and third party system 105).

In one or more arrangements, carbon emission optimization platform 102, task execution platform 103, user device 104, and third party system 105 may be any type of computing device capable of receiving a user interface, receiving input via the user interface, and communicating the received input to one or more other computing devices, and/or training, hosting, executing, and/or otherwise maintaining one or more machine learning models. For example, carbon emission optimization platform 102, task execution platform 103, user device 104, third party system 105, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of carbon emission optimization platform 102, task execution platform 103, user device 104, and third party system 105 may, in some instances, be special-purpose computing devices configured to perform specific functions.

Referring to FIG. 1B, carbon emission optimization platform 102 may include one or more processors 111, memory 112, and communication interface 113. A data bus may interconnect processor 111, memory 112, and communication interface 113. Communication interface 113 may be a network interface configured to support communication between carbon emission optimization platform 102 and one or more networks (e.g., network 101, or the like). Memory 112 may include one or more program modules having instructions that when executed by processor 111 cause carbon emission optimization platform 102 to perform one or more functions described herein and/or one or more databases that may store and/or otherwise maintain information which may be used by such program modules and/or processor 111. In some instances, the one or more program modules and/or databases may be stored by and/or maintained in different memory units of carbon emission optimization platform 102 and/or by different computing devices that may form and/or otherwise make up carbon emission optimization platform 102. For example, memory 112 may have, host, store, and/or include carbon emission optimization engine 112a, carbon emission optimization database 112b, and machine learning engine 112c. Carbon emission optimization engine 112a may have instructions that direct and/or cause carbon emission optimization platform 102 to execute advanced techniques to perform real time carbon aware resource allocation for GPU intensive tasks. For example, the carbon emission optimization engine 112a may train, deploy, and/or otherwise refine a CO2 minimization model through both initial training and one or more dynamic feedback loops which may, e.g., enable continuous improvement of the models and further optimize the models for performing effective and accurate CO2 emission optimization. Carbon emission optimization database 112b may store information that may be used by the carbon emission optimization platform 102 and/or carbon emission optimization engine 112a to effectively execute compute intensive tasks while minimizing CO2 emissions. Machine learning engine 112c may be configured to train, host, and/or otherwise refine the CO2 minimization model, which may e.g., be used to generate recommendations for resource allocation in compute intensive tasks to minimize CO2 emissions and/or automatically implement a resource allocation accordingly.

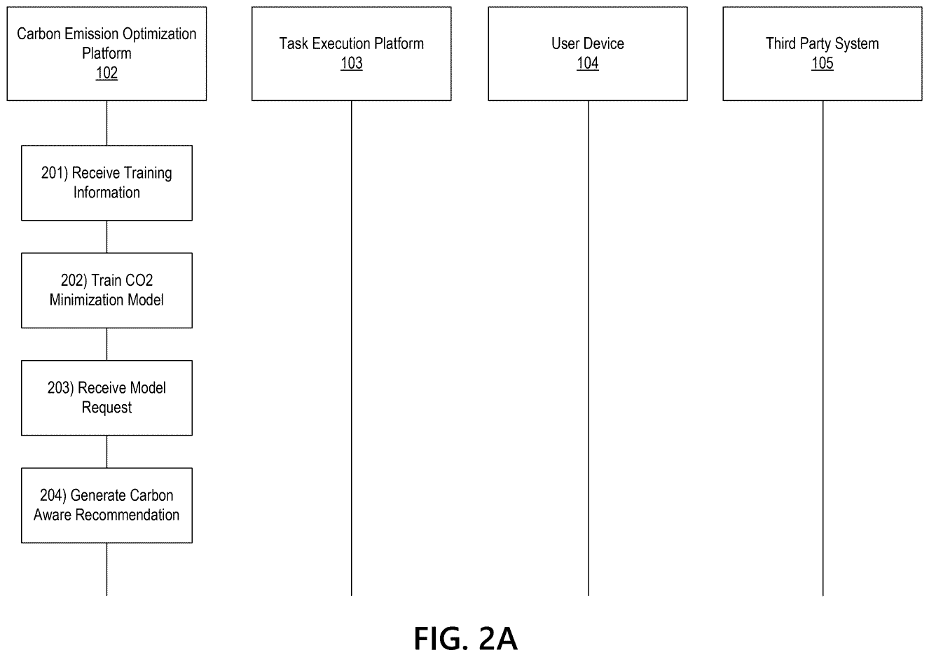

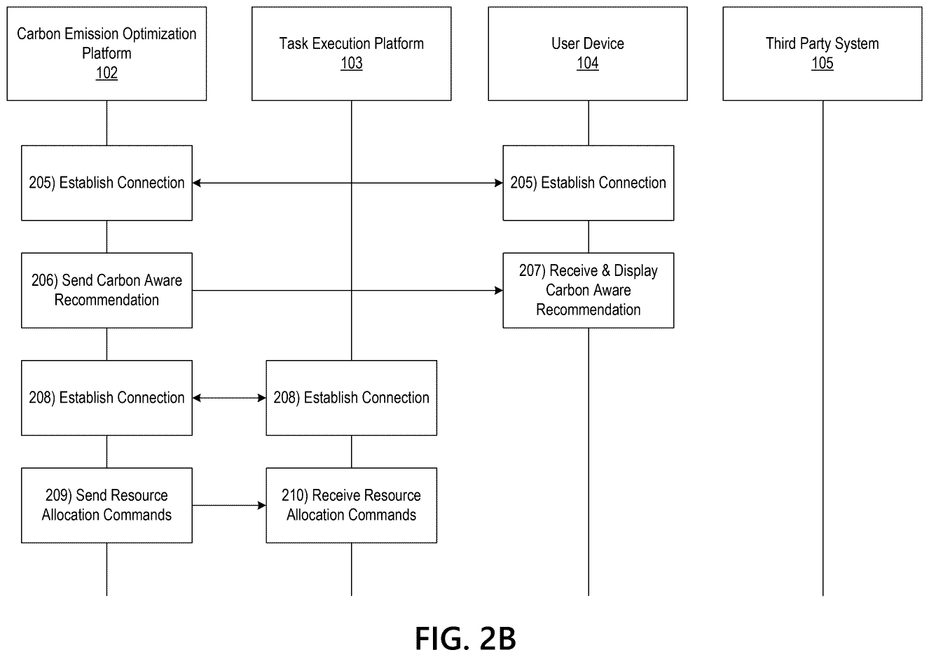

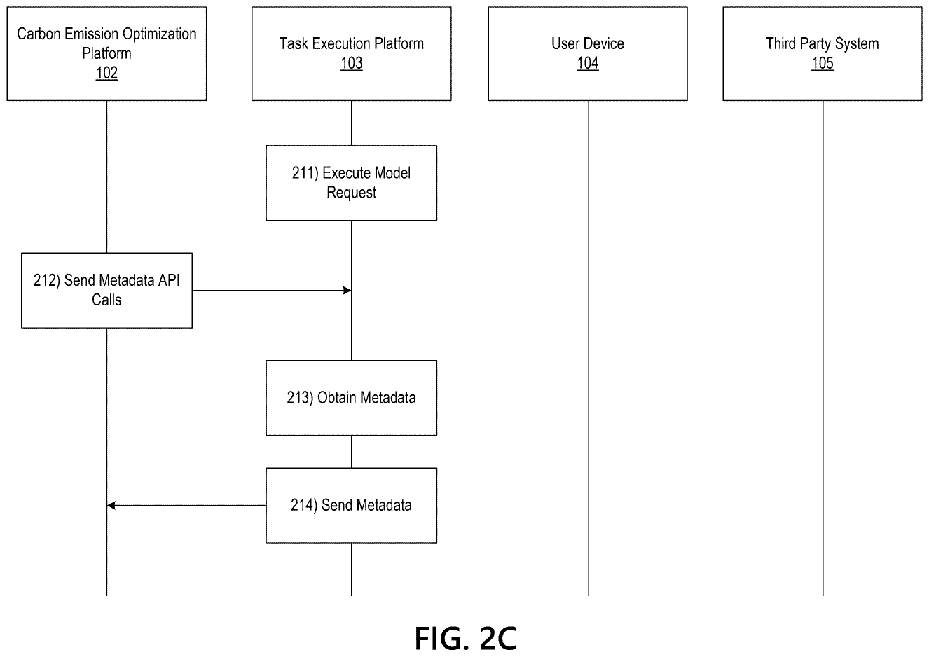

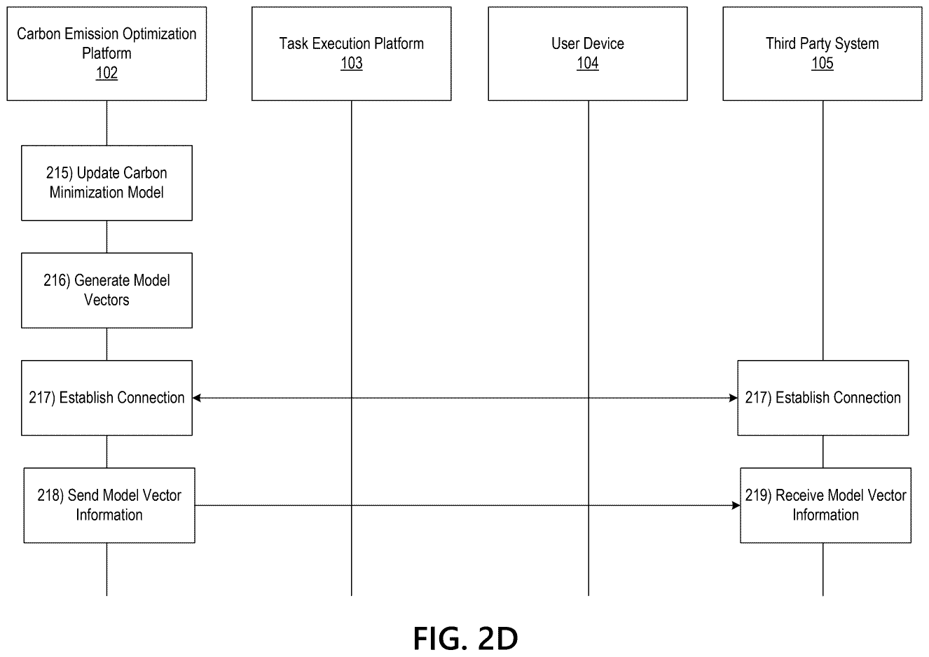

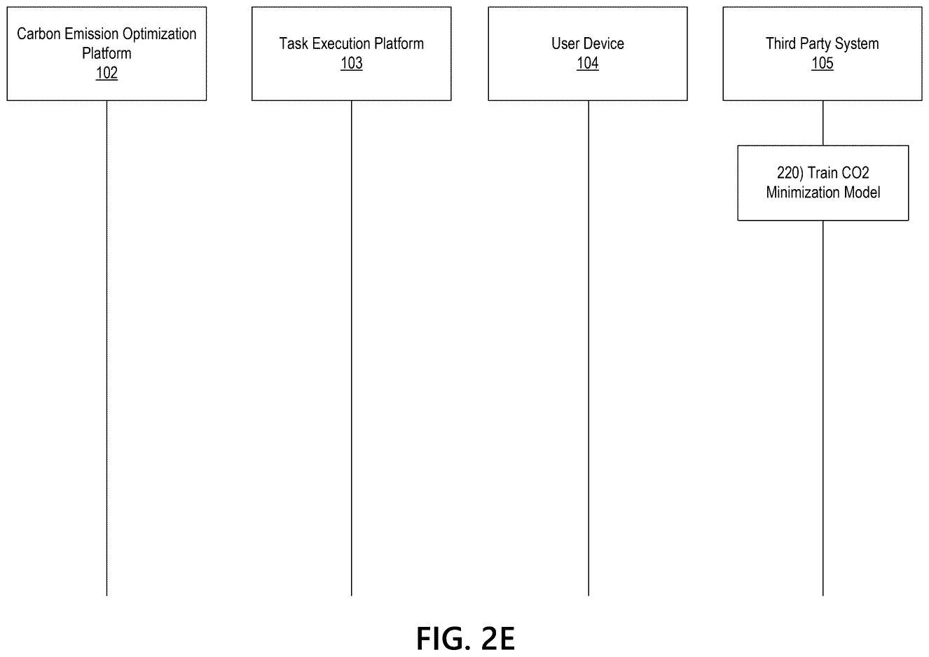

FIGS. 2A-2E depict an illustrative event sequence for performing real time carbon aware resource allocation for graphics processing unit (GPU) intensive tasks in accordance with one or more example embodiments. Referring to FIG. 2A, at step 201, carbon emission optimization platform 102 may receive model training information. For example, the carbon emission optimization platform 102 may receive code specific information (e.g., historical information (e.g., training information, run information, infrastructure history information, carbon emission history information, code history cache information, or the like), task information (high frequency trading information, gaming information, generative artificial intelligence information, computer vision information, natural language processing information, augmented reality information, virtual reality information, blockchain information, crypto currency information, or the like), model type information, or the like), temporal information (day information, time information, holiday information, or the like), compute specific information (infrastructure information (e.g., thermal design power information, graphics processing unit (GPU) lifespan information, hardware information, recycling information, cooling information, GPU type, GPU name, GPU memory, central processing unit (CPU) type, CPU name, CPU memory, or the like), geographical information (e.g., country information, state information, distance information, or the like), energy information (energy source information (e.g., a coal source, a solar source, a wind source, a nuclear source, a hydro source, a natural gas source, or the like), grid information, carbon intensity information indicating a kilogram (kg) per mega watt hour of CO2 emission for a corresponding energy source, or the like), or the like), codebase information, and/or other information. For example, the carbon emission optimization platform 102 may receive the model training information via the communication interface 113

At step 202, the carbon emission optimization platform 102 may train a CO2 minimization model. For example, the carbon emission optimization platform 102 may train the CO2 minimization model to produce resource allocation recommendations (e.g., indicating which computing resources should be used to execute a particular task to minimize CO2 emissions, or the like), carbon aware infrastructure recommendations (e.g., indicating context for how much CO2 emission may be saved by using the recommended resources, or the like), and/or other outputs. To do so, the CO2 minimization model may be trained to identify, for different computing resources available for processing different tasks, the corresponding CO2 emission costs, and select resources to minimize such costs accordingly. In some instances, the CO2 minimization model may be further trained to identify, for different resources available for processing different tasks, the corresponding monetary costs, and may modify the recommended resources accordingly.

In some instances, to perform such training, the carbon emission optimization platform 102 may use the model training information received at step 201. For example, the carbon emission optimization platform 102 may use the code specific information, codebase information, temporal information, compute specific information, and/or other information to establish stored correlations between CO2 emissions and the processing of a given task under particular conditions. Additionally or alternatively, the carbon emission optimization platform 102 may use this same information, along with historical cost information, to establish stored correlations between the cost of processing a given task under particular conditions using different energy sources, processing resources, or the like. In some instances, the carbon emission optimization platform 102 may be configured to apply different weights to the CO2 emissions and the monetary cost (e.g., apply a .5 weighting to the CO2 emissions and .5 weighting to the monetary cost, or the like), which may, e.g., be adjusted on a regular, predetermined, and/or other basis. In doing so, the carbon emission optimization platform 102 may configure the CO2 minimization model to select resources for processing a given request that enable processing of the request while minimizing the amount of CO2 emissions associated with such processing. In some instances, the CO2 minimization model may further balance cost considerations along with the CO₂ emissions (i.e., different processing resources than those identified as minimizing the CO2 emissions may be selected based on a differential in cost between the selected processing resources and those identified as minimizing the CO2 emissions). In some instances, the CO2 minimization model may be trained to output information of the identified processing resources to be used in automatically causing processing of the requested task via the identified processing resources, a recommendation to use the identified processing resources that may be displayed at a user device and used to make a decision on processing resources (which may, e.g., indicate a potential CO2 emissions savings), and/or other outputs.

In some instances, in training the CO2 minimization model, the carbon emission optimization platform 102 may use one or more supervised learning techniques (e.g., decision trees, bagging, boosting, random forest, k-NN, linear regression, artificial neural networks, support vector machines, and/or other supervised learning techniques), unsupervised learning techniques (e.g., classification, regression, clustering, anomaly detection, artificial neutral networks, and/or other unsupervised models/techniques), and/or other techniques.

At step 203, the carbon emission optimization platform 102 may receive a model request, such as a request to execute a task related to high frequency trading, gaming, generate AI, computer vision, natural language processing, AR, VR, blockchain, crypto, or the like. In some instances, the carbon emission optimization platform 102 may receive the model request from a user device, such as the user device 104 (e.g., via the communication interface 113). In some instances, the request may be to execute a task for which processing by one or more GPUs is necessary.

At step 204, the carbon emission optimization platform 102 may produce a carbon aware infrastructure recommendation and/or resource allocation information. For example, the carbon emission optimization platform 102 may feed information of the model request, task information, and/or other information, received at step 203, into the CO2 minimization model.

The CO2 minimization model may establish a correlation between the information input at step 204 and the available resources for processing the corresponding request. For example, the CO2 minimization model may identify a plurality of available resources for executing and/or otherwise processing the corresponding request, along with the corresponding CO2 emissions and/or monetary costs associated with such processing. The CO2 minimization model may then rank the resources according to the CO2 emissions (e.g., in terms of which emissions lowest to which emissions are highest) and/or monetary cost (e.g., lowest cost to highest cost). The CO2 minimization may then select resources to recommend based on these rankings (e.g., by selecting the resources ranked highest according to CO2 emissions and/or monetary cost).

In some instances, the CO2 minimization model may generate resource allocation information, which may, e.g., indicate the selected resources (and/or a mapping between executable code for processing the task and the selected resources), and may be used to send automated commands to the task execution platform 103 that cause the task execution platform 103 to execute the request using the selected resources (e.g., as is described in steps 208-212). Additionally or alternatively, the CO2 minimization model may generate carbon aware infrastructure recommendations, which may be displayed at the user device 104 (e.g., as is described in steps 206/207). In some instances, in generating the carbon aware infrastructure recommendation, the CO2 minimization model may generate a recommendation indicating the selected resources, as well as an indication of the corresponding CO2 emissions saved.

Referring to FIG. 2B, at step 205, the carbon emission optimization platform 102 may establish a connection with the user device 104. For example, the carbon emission optimization platform 102 may establish a first wireless data connection with the user device 104 to link the carbon emission optimization platform 102 to the user device 104 (e.g., in preparation for sending carbon aware recommendations). In some instances, the carbon emission optimization platform 102 may identify whether or not a connection is already established with the user device 104. If a connection is already established, the carbon emission optimization platform 102 might not re-establish the connection. Otherwise, if a connection is not yet established, the carbon emission optimization platform 102 may establish the first wireless data connection as described herein.

At step 206, the carbon emission optimization platform 102 may send the carbon aware infrastructure recommendation to the user device 104. For example, the carbon emission optimization platform 102 may send the carbon aware infrastructure recommendation to the user device 104 via the communication interface 113 and while the first wireless data connection is established. In some instances, the carbon emission optimization platform 102 may also send one or more commands that may cause the user device 104 to display the carbon aware infrastructure recommendation.

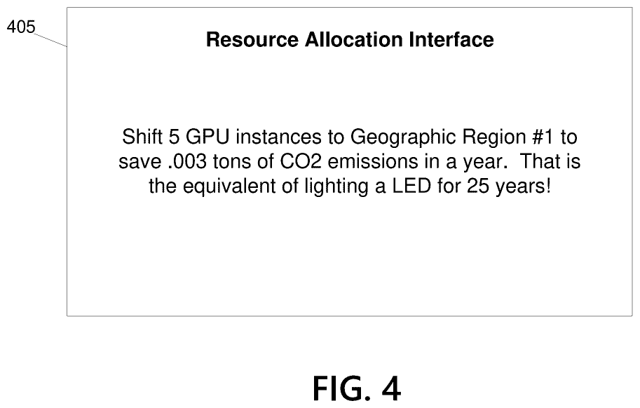

At step 207, the user device 104 may receive the carbon aware infrastructure recommendation sent at step 206. Based on or in response to the one or more commands directing the user device 104 to display the carbon aware infrastructure recommendation, the user device 104 may display the carbon aware infrastructure recommendation. For example, the user device 104 may display a carbon aware infrastructure recommendation similar to the recommendation displayed in graphical user interface 405, which is illustrated in FIG. 4. For example, the user device 104 may display a graphical user interface that indicates particular processing resources that, if used to process the requested task, would minimize CO2 emissions. In some instances, the graphical user interface may also indicate what the CO2 emission savings may be, as well as a real world comparison of what those savings may be comparable to (e.g., lighting a LED for a particular time period, planting a particular number of plants, or the like). For example, the carbon aware infrastructure recommendation may indicate “Shift model to edge device to save .002 tons of CO2 emissions in a year. That is equivalent to 1/10 seeding grown in 5 years!”, and may, in some instances, include a relevant graphic (e.g., a leaf, tree, plant, or the like). As another example, the carbon aware infrastructure recommendation may indicate “Shift 5 GPU instances to Geographical Region #1 to save .003 tons of CO2 emissions in a year that can light a LED for 25 years,” and may include a relevant graphic (e.g., a lightbulb, etc.). As another example, the carbon aware infrastructure recommendation may indicate “Shift code A to CPU x to save .002 CO2 emissions in a year.” As yet another example, the carbon aware infrastructure recommendation may indicate “Shift code B to GPU to save .001 tons of CO2 emissions per month.” Other similar recommendations may be generated/displayed without departing from the scope of the disclosure.

At step 208, the carbon emission optimization platform 102 may establish a connection with the task execution platform 103. For example, the carbon emission optimization platform 102 may establish a second wireless data connection with the task execution platform 103 (e.g., in preparation for sending resource allocation commands). In some instances, the carbon emission optimization platform 102 may identify whether or not a connection is already established with the task execution platform 103. If a connection is already established with the task execution platform 103, the carbon emission optimization platform 102 might not re-establish the connection. If a connection is not yet established with the task execution platform 103, the carbon emission optimization platform 102 may establish the second wireless data connection as described herein.

At step 209, the carbon emission optimization platform 102 may send resource allocation commands to the task execution platform 103. For example, the carbon emission optimization platform 102 may send the resource allocation commands to the task execution platform 103 via the communication interface 113 and while the second wireless data connection is established. In some instances, these resource allocation commands may specify the resources identified by the CO2 minimization model, and may automatically trigger processing of the requested tasks by the identified resources of the tasks execution platform 103.

At step 210, the task execution platform 103 may receive the resource allocation commands sent at step 209. For example, the task execution platform 103 may receive the resource allocation commands while the second wireless data connection is established.

Referring to FIG. 2C, at step 211, based on or in response to the resource allocation commands, the task execution platform 103 may execute and/or otherwise process the received task/request using the identified resources (e.g., one or more specified GPUs, CPUs, or the like). In doing so, the task execution platform 103 may generate less CO2 emissions than would be generated if different resources were used to execute/process the task/request and/or have a lower monetary cost than if the task/request was processed using different resources.

At step 212, the carbon emission optimization platform 102 may continually monitor the task execution platform 103 until completion of the requested task. For example, the carbon emission optimization platform 102 may send one or more application programming interface (API) calls requesting metadata associated with the processing of the requested task. For example, the carbon emission optimization platform 102 may request real time metadata including energy consumption, memory bandwidth, device utilization, dynamic carbon saving parameters, static carbon saving parameters (e.g., resource lifespan information, recycling information, task information, hardware information, TDP information, or the like), or the like, which may, e.g., be associated with GPUs, CPUs, or the like that may be currently handling the requested task. In some instances, the carbon emission optimization platform 102 may send the API calls to the task execution platform 103 via the communication interface 113 and while the second wireless data connection is established.

At step 213, the task execution platform 103 may receive the API calls sent at step 212, and may obtain the corresponding metadata. For example, the task execution platform 103 may obtain the energy consumption, memory bandwidth, device utilization, dynamic carbon saving parameters, static carbon saving parameters (e.g., resource lifespan information, recycling information, task information, hardware information, TDP information, or the like), or the like, which may, e.g., be associated with GPUs, CPUs, or the like that may be currently handling the requested task.

At step 214, the task execution platform 103 may send the collected metadata to the carbon emission optimization platform 102. For example, the task execution platform 103 may send the metadata to the carbon emission optimization platform 102 while the second wireless data connection is established.

Referring to FIG. 2D, at step 215, the carbon emission optimization platform 102 may receive the metadata sent at step 214, and may update the CO2 minimization model based on the metadata. For example, the carbon emission optimization platform 102 may feed the metadata into the CO2 minimization model, which may, e.g., result in different operating conditions than when the initial model output was produced at step 204. Accordingly, the carbon emission optimization platform 102 may return to step 204 to update the carbon aware recommendation/resource allocation information. Steps 204-215 may be continuously repeated until completion of the task/request. In doing so, processing may be dynamically shifted by the carbon emission optimization platform 102/task execution platform 103 to minimize CO2 emissions and/or monetary cost of the processing in light of the changing conditions experienced over the course of the processing itself.

At step 216, the carbon emission optimization platform 102 may generate green house gas (GHG) vectors associated with the CO₂ minimization model. For example, these GHG vectors may, for example, be used to replicate the CO2 minimization model without repeating the initial training process described at step 202.

At step 217, the carbon emission optimization platform 102 may establish a connection with the third party system 105. For example, the carbon emission optimization platform 102 may establish a third wireless data connection with the third party system 105 to link the carbon emission optimization platform 102 to the third party system 105 (e.g., in preparation for distributing the GHG vectors). In some instances, the carbon emission optimization platform 102 may identify whether or not a connection is already established with the third party system 105. If a connection is already established with the third party system 105, the carbon emission optimization platform 102 might not re-establish the connection. Otherwise, if a connection is not yet established with the third party system 105, the carbon emission optimization platform 102 may establish the third wireless connection as described herein.

At step 218, the carbon emission optimization platform 102 may send the GHG vector information to the third party system 105. For example, the carbon emission optimization platform 102 may send the GHG vector information to the third party system 105 via the communication interface 113 and while the third wireless data connection is established.

At step 219, the third party system 105 may receive the GHG vector information sent at step 218. For example, the third party system 105 may receive the GHG vector information while the third wireless data connection is established.

Referring to FIG. 2E, at step 220, the third party system 105 may train an instance of the CO2 minimization model using the GHG vector information. For example, the third party system 105 may train this CO2 minimization model in a much quicker manner than the training of the CO2 minimization model by the carbon emission optimization platform 102 at step 202 by utilizing the GHG vector information that has already been determined by the carbon emission optimization platform 102. Once trained, the third party system 105 may deploy this instance of the CO2 minimization model for use as is described above with regard to steps 203-215, which may e.g., provide additional savings in CO2 emissions, cost, and/or otherwise beyond that achieved solely by the carbon emission optimization platform 102 and the initial instance of the CO2 minimization model.

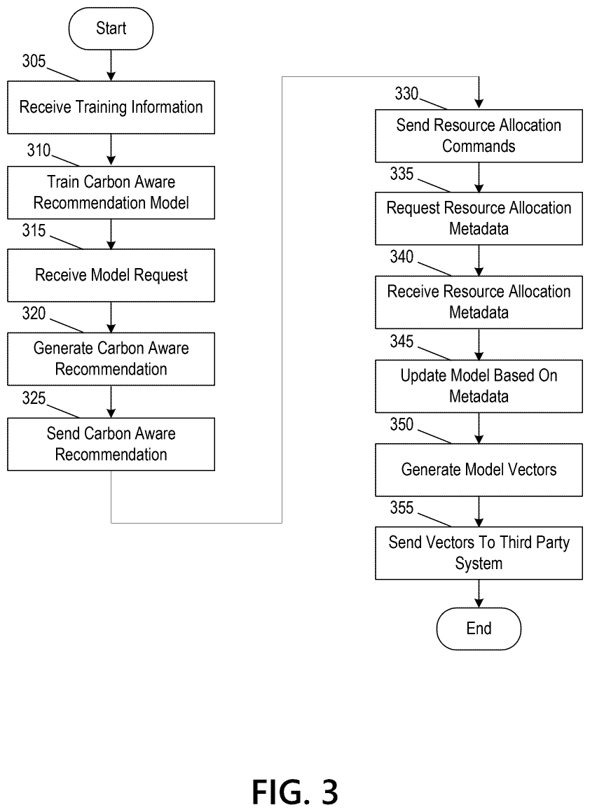

FIG. 3 depicts an illustrative method for performing real time carbon aware resource allocation for graphics processing unit (GPU) intensive tasks in accordance with one or more example embodiments. Referring to FIG. 3, at step 305, a computing platform comprising one or more processors, memory, and a communication interface may receive model training information. At step 310, the computing platform may train a carbon aware recommendation model (e.g., a CO2 minimization model) using the model training information. At step 315, the computing platform may receive a request to implement the carbon aware recommendation model (e.g., a request to execute a task, or the like). At step 320, the computing platform may input the request into the carbon aware recommendation model to output a carbon aware recommendation. At step 325, the computing platform may send the carbon aware recommendation to a user device for display. At step 330, the computing platform may send resource allocation commands to a task execution system directing the task execution system to implement the recommended resource allocation (which may, e.g., cause the task execution system to implement the resource allocation). At step 335, the computing platform may request metadata associated with implementation of the resource allocation. At step 340, the computing platform may receive the requested metadata. At step 345, the computing platform may update the carbon aware recommendation model based on the metadata. At step 350, the computing platform may generate model vectors based on the carbon aware recommendation model. At step 355, the computing platform may send the vectors to one or more third party systems, which may be used to implement carbon aware recommendation models at these third party systems accordingly.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
train, using code specific information, temporal information, and compute specific information, a carbon dioxide (CO2) minimization model, wherein training the CO2 minimization model configures the CO2 minimization model to output, for a given processing request, a resource allocation recommendation;
receive a first processing request;
input the first processing request into the CO2 minimization model, wherein inputting the first processing request into the CO2 minimization model causes the CO2 minimization model to output a first resource allocation recommendation indicating processing resources for use in executing the first processing request with a minimal amount of CO2 emissions;
send one or more commands to a task execution platform directing the task execution platform to execute the first processing request using the processing resources of the first resource allocation recommendation, wherein sending the one or more commands causes the task execution platform to execute the first processing request using the processing resources of the first resource allocation recommendation;
until completion of the first processing request:
dynamically monitor the task execution platform to collect, in real time, metadata associated with execution of the first processing request,
generate, using the CO2 minimization model, updated resource allocation recommendations based on the real time metadata,
send updated commands to the task execution platform directing the task execution platform to shift processing for the first processing request to updated resources indicated in the updated resource allocation recommendations, wherein sending the updated commands causes the task execution platform to shift the processing for the first processing request to the updated resources; and
update, based on the real time metadata, the CO2 minimization model.

2. The computing platform of claim 1, wherein the code specific information comprises one or more of:
historical information comprising one or more of: training information, run information, infrastructure history information, carbon emission history information, or code history cache information,
task information comprising one or more of: high frequency trading information, gaming information, generative artificial intelligence information, computer vision information, natural language processing information, augmented reality information, virtual reality information, blockchain information, or crypto currency information, or
model type information.

3. The computing platform of claim 1, wherein the temporal information comprises one or more of: day information, time information, or holiday information.

4. The computing platform of claim 1, wherein the compute specific information comprises one or more of:
infrastructure information comprising one or more of: thermal design power information, graphics processing unit (GPU) lifespan information, hardware information, recycling information, cooling information, GPU type, GPU name, GPU memory, central processing unit (CPU) type, CPU name, or CPU memory,
geographical information comprising one or more of: country information, state information, or distance information, or
energy information comprising one or more of: energy source information, grid information, or carbon intensity information, wherein the carbon intensity information indicates a kilogram (kg) per mega watt hour of CO2 emission for a corresponding energy source, and wherein the corresponding energy source comprises one or more of: a coal source, a solar source, a wind source, a nuclear source, a hydro source, or a natural gas source.

5. The computing platform of claim 1, wherein the given processing request comprises a request to process a task using a GPU.

6. The computing platform of claim 1, wherein the processing resources are associated with a codebase, and wherein the CO2 minimization model is further trained using the codebase.

7. The computing platform of claim 1, wherein the real time metadata comprises one or more of: energy consumption, memory bandwidth, device utilization, dynamic carbon saving parameters, or static carbon saving parameters, wherein the static carbon saving parameters comprise one or more of: resource lifespan information, recycling information, task information, hardware information, or TDP information.

8. The computing platform of claim 1, wherein the first resource allocation recommendation comprises a mapping for execution of a code associated with the first processing request to a particular processing resource.

9. The computing platform of claim 1, wherein the memory stores additional computer readable instructions that, when executed by the at least one processor, cause the computing platform to:
send, to a user device associated with the first processing request, a carbon aware infrastructure recommendation based on the resource allocation recommendation, wherein the carbon aware infrastructure recommendation provides an indication of an amount of CO2 savings associated with implementation of the resource allocation recommendation, and wherein sending the carbon aware infrastructure recommendation causes the user device to display the carbon aware infrastructure recommendation.

10. The computing platform of claim 1, wherein the memory stores additional computer readable instructions that, when executed by the at least one processor, cause the computing platform to:
generate, based on the CO2 minimization model, green house gas (GHG) vectors; and
send, to a third party system, the GHG vectors, wherein the third party system is configured to implement the CO2 minimization model based on the GHG vectors.

11. A method comprising:
at a computing platform comprising at least one processor, a communication interface, and memory:
training, using code specific information, temporal information, and compute specific information, a carbon di-oxide (CO2) minimization model, wherein training the CO2 minimization model configures the CO2 minimization model to output, for a given processing request, a resource allocation recommendation;
receiving a first processing request;
inputting the first processing request into the CO2 minimization model, wherein inputting the first processing request into the CO2 minimization model causes the CO2 minimization model to output a first resource allocation recommendation indicating processing resources for use in executing the first processing request with a minimal amount of CO2 emissions;
sending one or more commands to a task execution platform directing the task execution platform to execute the first processing request using the processing resources of the first resource allocation recommendation, wherein sending the one or more commands causes the task execution platform to execute the first processing request using the processing resources of the first resource allocation recommendation;
until completion of the first processing request:
dynamically monitoring the task execution platform to collect, in real time, metadata associated with execution of the first processing request,
generating, using the CO2 minimization model, updated resource allocation recommendations based on the real time metadata, and
sending updated commands to the task execution platform directing the task execution platform to shift processing for the first processing request to updated resources indicated in the updated resource allocation recommendations, wherein sending the updated commands causes the task execution platform to shift the processing for the first processing request to the updated resources; and
updating, based on the real time metadata, the CO2 minimization model.

12. The method of claim 11, wherein the code specific information comprises one or more of:
historical information comprising one or more of: training information, run information, infrastructure history information, carbon emission history information, or code history cache information,
task information comprising one or more of: high frequency trading information, gaming information, generative artificial intelligence information, computer vision information, natural language processing information, augmented reality information, virtual reality information, blockchain information, or crypto currency information, or
model type information.

13. The method of claim 11, wherein the temporal information comprises one or more of: day information, time information, or holiday information.

14. The method of claim 11, wherein the compute specific information comprises one or more of:
infrastructure information comprising one or more of: thermal design power information, graphics processing unit (GPU) lifespan information, hardware information, recycling information, cooling information, GPU type, GPU name, GPU memory, central processing unit (CPU) type, CPU name, or CPU memory,
geographical information comprising one or more of: country information, state information, or distance information, or
energy information comprising one or more of: energy source information, grid information, or carbon intensity information, wherein the carbon intensity information indicates a kilogram (kg) per mega watt hour of CO2 emission for a corresponding energy source, and wherein the corresponding energy source comprises one or more of: a coal source, a solar source, a wind source, a nuclear source, a hydro source, or a natural gas source.

15. The method of claim 11, wherein the given processing request comprises a request to process a task using a GPU.

16. The method of claim 11, wherein the processing resources are associated with a codebase, and wherein the CO2 minimization model is further trained using the codebase.

17. The method of claim 11, wherein the real time metadata comprises one or more of:
energy consumption, memory bandwidth, device utilization, dynamic carbon saving parameters, or static carbon saving parameters, wherein the static carbon saving parameters comprise one or more of: resource lifespan information, recycling information, task information, hardware information, or TDP information.

18. The method of claim 11, wherein the first resource allocation recommendation comprises a mapping for execution of a code associated with the first processing request to a particular processing resource.

19. The method of claim 11, further comprising:
sending, to a user device associated with the first processing request, a carbon aware infrastructure recommendation based on the resource allocation recommendation, wherein the carbon aware infrastructure recommendation provides an indication of an amount of CO2 savings associated with implementation of the resource allocation recommendation, and wherein sending the carbon aware infrastructure recommendation causes the user device to display the carbon aware infrastructure recommendation.

20. One or more non-transitory computer-readable media storing instructions that, when executed by a computing platform comprising at least one processor, a communication interface, and memory, cause the computing platform to:
train, using code specific information, temporal information, and compute specific information, a carbon di-oxide (CO2) minimization model, wherein training the CO2 minimization model configures the CO2 minimization model to output, for a given processing request, a resource allocation recommendation;
receive a first processing request;
input the first processing request into the CO2 minimization model, wherein inputting the first processing request into the CO2 minimization model causes the CO2 minimization model to output a first resource allocation recommendation indicating processing resources for use in executing the first processing request with a minimal amount of CO2 emissions;
send one or more commands to a task execution platform directing the task execution platform to execute the first processing request using the processing resources of the first resource allocation recommendation, wherein sending the one or more commands causes the task execution platform to execute the first processing request using the processing resources of the first resource allocation recommendation;
until completion of the first processing request:
dynamically monitor the task execution platform to collect, in real time, metadata associated with execution of the first processing request,
generate, using the CO2 minimization model, updated resource allocation recommendations based on the real time metadata, and
send updated commands to the task execution platform directing the task execution platform to shift processing for the first processing request to updated resources indicated in the updated resource allocation recommendations, wherein sending the updated commands causes the task execution platform to shift the processing for the first processing request to the updated resources; and
update, based on the real time metadata, the CO2 minimization model.
